(19) United States
(12) Patent Application Publication
(10) Pub. No.: US 2006/0240291 A1
(43) Pub. Date: Oct. 26, 2006

(54) Power supply apparatus using fuel cell and method of controlling the same

(75) Inventors: Young-Jae Kim, Seoul (KR); Hyuk Chang, Seongnam-si (KR); Dong-kee Sohn, Seoul (KR); Kyoung Hwan Choi, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/388,974

(22) Filed: Mar. 27, 2006

(30) Foreign Application Priority Data
Apr. 21, 2005 (KR) 2005-33198

(51) Int. Cl. H01M 16/00; H02J 7/00; H01M 10/46; H01M 8/04

(52) U.S. Cl. 429/9; 320/101; 429/23; 429/61; 429/13; 429/50

(57) ABSTRACT

A power supply apparatus having a fuel cell and a rechargeable battery and a method of controlling power supplied by the apparatus to a load. A DC-DC converter is selectively supplied with power from the fuel cell or from the fuel cell and the battery based on an amount of a load current. The battery is recharged from an output of the DC-DC converter to increase an overall efficiency of the DC-DC converter and the fuel cell when the load current is low. The battery supplements power input to the DC-DC converter when the load current is high or when an output voltage of the fuel cell becomes unstable.

### CROSS-REFERENCE TO RELATED APPLICATIONS

This application claims the benefit of Korean Application No. 2005-33198, filed Apr. 21, 2005, in the Korean Intellectual Property Office, the disclosure of which is incorporated herein by reference.

### BACKGROUND OF THE INVENTION

1. Field of the Invention

Aspects of the present invention relate to an apparatus for supplying power to a load by converting a voltage output from a fuel cell using a DC-DC converter, and a method of controlling the power supply apparatus, and more particularly, to a power supply apparatus for controlling connections between a rechargeable battery, a fuel cell and a DC-DC converter according to a current flowing through a load, and a method of controlling the same.

2. Description of the Related Art

A fuel cell is an electrochemical device which directly converts chemical energy of hydrogen and oxygen contained in a hydrocarbon series substance such as methanol, ethanol, or natural gas, into electrical energy. The energy conversion process of the fuel cell is very efficient and environmentally friendly, and over the last few decades various kinds of fuel cells have been suggested.

The fuel cell is similar to a general chemical cell in terms of using an oxidation reaction and a deoxidation reaction. However, unlike the chemical cell, in which a cell reaction is performed in a closed system, the fuel cell continuously intakes reaction materials and continuously discharges reaction products.

Power consumption of a load connected to a power supply apparatus varies. For example, when a cell-phone is connected to the power supply apparatus, the cell-phone consumes a very low power in an idle mode, but a high power during a phone-call, short message transmission, or data access. Since an output voltage of the power supply apparatus varies in response to changes of the power supplied to the load, the power supply apparatus includes a DC-DC converter to maintain a stable output voltage.

FIG. 1 is a diagram illustrating a correlation between load current and output voltage of a fuel cell in a power supply apparatus. As described above, the power supplied to the load varies according to a state of the load, and the load current supplied by the power supply apparatus varies according to changes of the supply of power. As shown in FIG. 1, since the output voltage of the fuel cell decreases as the load current increases, the output voltage of the fuel cell is unstable.

FIGS. 2A and 2B are diagrams illustrating a correlation between load current and efficiency of a DC-DC converter in a power supply apparatus using a fuel cell, when a step up DC-DC converter is used to increase a DC voltage output by the fuel cell. As described above, the output voltage of the fuel cell and the efficiency of the DC-DC converter both decrease as the load current increases above a certain value of the load current.

FIG. 2A shows the correlation between the load current and the efficiency of the DC-DC converter at rated output voltages of 3.2V, 3.4V, 3.6V, and 3.8V of the fuel cell. As described above, the efficiency of the DC-DC converter decreases as the load current increases. FIG. 2B shows the correlation between the load current and the efficiency of the DC-DC converter at rated output voltages of 5V, 6V, and 7.4V of the fuel cell. In these cases, the efficiency of the DC-DC converter also decreases as the load current increases.

Thus, when power is supplied to a load from a power supply apparatus using a conventional fuel cell, the efficiency of a DC-DC converter included in the power supply apparatus varies according to changes in the power consumed by the load, thereby causing reduced power supply efficiency.

### SUMMARY OF THE INVENTION

Aspects of the present invention provide a power supply apparatus for maintaining a high efficiency of a DC-DC converter by controlling connections between a rechargeable battery and a DC-DC converter being supplied by the fuel cell according to a current flowing to a load, and a method of controlling the same.

According to an aspect of the present invention, there is provided a power supply apparatus comprising: a fuel cell; a rechargeable battery; a DC-DC converter converting a voltage input from the fuel cell or the fuel cell and the rechargeable battery to a voltage to be supplied to a load; a current measurement unit measuring a current which is output from the DC-DC converter and flowing to the load; and a controller controlling a connection between the rechargeable battery and an input and an output of the DC-DC converter and determining whether a voltage is input from the rechargeable battery to the DC-DC converter according to the measured load current, and whether the rechargeable battery is charged using power supplied by the DC-DC converter.

The controller may connect the rechargeable battery to the output of the DC-DC converter to charge the rechargeable battery using the power supplied by the DC-DC converter if the measured load current is less than a first value.

The controller may disconnect the rechargeable battery from the input and output of the DC-DC converter if the measured load current is greater than the first value and less than a second value.

The controller may connect the rechargeable battery to the input of the DC-DC converter to input the voltage from the rechargeable battery to the DC-DC converter if the measured load current is greater than the second value.

The second value may be set to maintain a predetermined efficiency of the DC-DC converter.

The controller may comprise: a mode determinator determining a current state of the power supply apparatus to be a first mode if the measured load current is less than the first load current, to be a second mode if the measured load current is greater than the first load current and less than the second value, and to be a third mode if the measured load current is greater than the second value; and a switching controller connecting the rechargeable battery to the output of the DC-DC converter if the current state of the power supply apparatus is the first mode, disconnecting the rechargeable battery from the input and output of the DC-DC converter if the current state of the power supply apparatus is the second mode, and connecting the rechargeable battery to the input of the DC-DC converter if the current state of the power supply apparatus is the third mode.

The power supply apparatus may further comprise a first voltage measurement unit measuring the output voltage of the rechargeable battery, and the controller may determine whether the rechargeable battery is fully charged using the output voltage of the rechargeable battery measured by the first voltage measurement unit and disconnect the rechargeable battery from the output of the DC-DC converter if the rechargeable battery is fully charged.

The power supply apparatus may further comprise a second voltage measurement unit measuring the output voltage of the fuel cell, and the controller may determine whether the power of the fuel cell is stable using the output voltage of the fuel cell measured by the second voltage measurement unit, and connect the rechargeable battery to the input of the DC-DC converter if the power of the fuel cell is unstable.

According to another aspect of the present invention, there is provided a method of controlling a power supply apparatus using a fuel cell, the method comprising: measuring a current which is output from a DC-DC converter and flows to a load; determining whether a voltage is input from the rechargeable battery to the DC-DC converter based on the measured load current, or whether the rechargeable battery is charged using power output by the DC-DC converter; and controlling a connection between the rechargeable battery and an input and an output of the DC-DC converter according to a result of the determining.

In the determining of whether the voltage is input from the rechargeable battery to the DC-DC converter, if the measured load current is less than a first load current, the rechargeable battery may be charged using the power output by the DC-DC converter. In the controlling of the connection, the rechargeable battery may be connected to the output of the DC-DC converter.

In the determining of whether the voltage is input from the rechargeable battery to the DC-DC converter, if the measured load current is greater than the first value, the voltage may be input from the rechargeable battery to the DC-DC converter. In the control of the connection, the rechargeable battery may be connected to the input of the DC-DC converter.

In the determination, a current state of the power supply apparatus may be determined to be a first mode if the measured load current is less than the first value, to be a second mode if the measured load current is greater than the first f value and less than the second value, and to be a third mode if the measured load current is greater than the second value, and in the control of the connection, the rechargeable battery may be connected to the output of the DC-DC converter if the current state of the power supply apparatus is the first mode, the rechargeable battery may be disconnected from the input and output of the DC-DC converter if the current state of the power supply apparatus is the second mode, and the rechargeable battery may be connected to the input of the DC-DC converter if the current state of the power supply apparatus is the third mode.

The method may further comprise: determining whether the rechargeable battery is fully charged by measuring the output voltage of the rechargeable battery, and if the rechargeable battery is fully charged, disconnecting the rechargeable battery from the output of the DC-DC converter.

The method may further comprise: determining whether the power of the fuel cell is stable by measuring the output voltage of the fuel cell, and if the power of the fuel cell is unstable, connecting the rechargeable battery to the input of the DC-DC converter.

According to another aspect of the present invention, there is provided a computer readable medium having recorded thereon a computer readable program for performing a method of controlling a power supply apparatus using a fuel cell.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating the correlation between load current and output voltage of a fuel cell in a power supply apparatus;

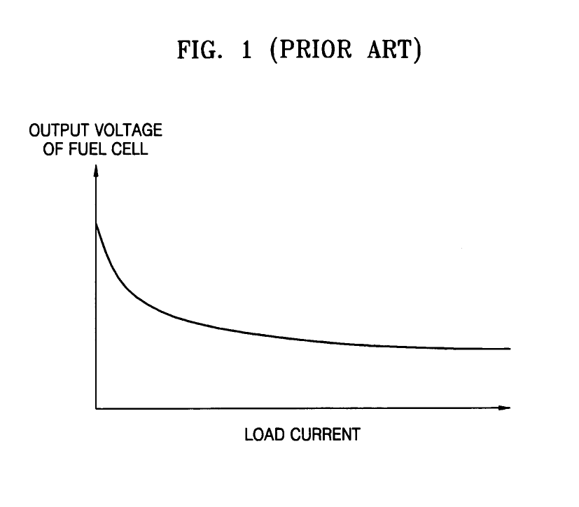

FIGS. 2A and 2B are diagrams illustrating the correlation between load current and the efficiency of a DC-DC converter in a power supply apparatus using a fuel cell;

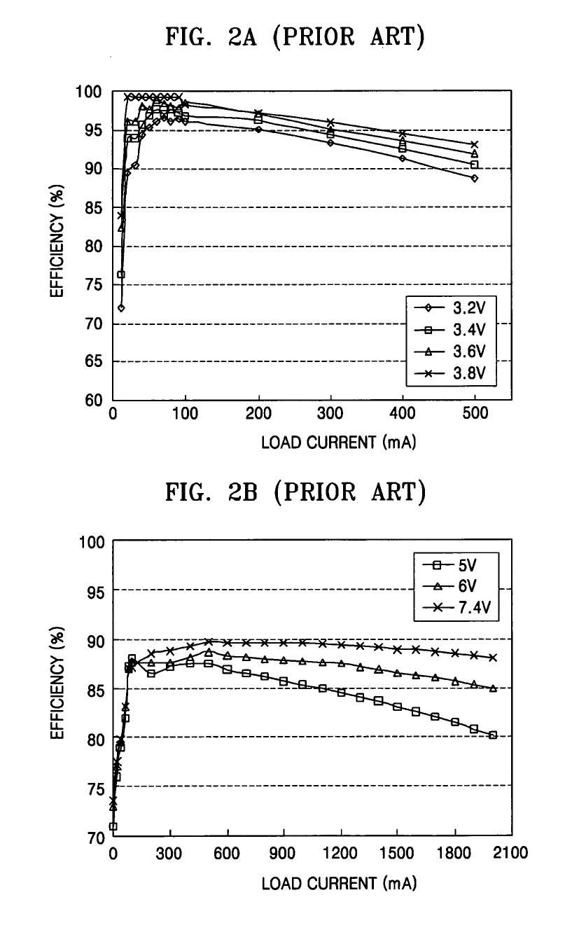

FIG. 3 is a block diagram of a power supply apparatus using a fuel cell according to an embodiment of the present invention;

FIG. 4 is a diagram illustrating a method of dividing a state of the power supply apparatus into three modes based on the load current;

FIG. 5 is a block diagram of another power supply apparatus using a fuel cell according to another embodiment of the present invention;

FIG. 6 is a flowchart illustrating a method of controlling the power supply apparatus using a fuel cell according to the embodiment shown in FIG. 3; and

FIG. 7 is a flowchart illustrating a method of controlling the other power supply apparatus using a fuel cell according to the embodiment shown in FIG. 5.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

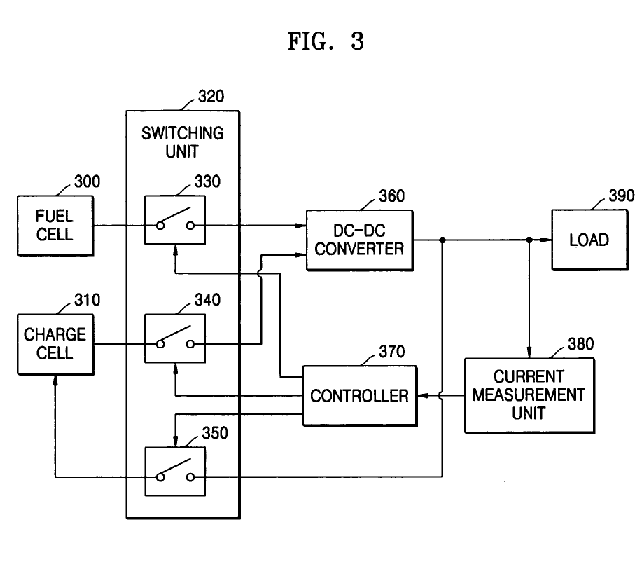

FIG. 3 is a block diagram of a power supply apparatus using a fuel cell according to an embodiment of the present invention. Referring to FIG. 3, the power supply apparatus includes a fuel cell 300, a rechargeable battery (charge cell) 310, a switching unit 320 including first, second and third switches 330, 340 and 350, respectively, a DC-DC converter 360, a controller 370, and a current measurement unit 380. An input of the DC-DC converter 360 is connected to the fuel cell 300 using the first switch 330, and to the rechargeable battery 310 using the second switch 340. Thus, a connection between the input of the DC-DC converter 360 and the fuel cell 300 is controlled by the first switch 330 and a connection between the DC-DC converter 360 and rechargeable battery 310 is controlled by the second switch 340.

The DC-DC converter 360 converts a DC voltage input from the fuel cell 300 and/or a DC voltage from the rechargeable battery 310 to a voltage to supply power to a load 390. An output of the DC-DC converter 360 is connected to the load 390 to supply the converted DC voltage to the load 390, and connected to the rechargeable battery 310 using the third switch 350 to supply a current output from the DC-DC converter 360 to the rechargeable battery when the third switch 350 is turned on. The current measurement unit 380 measures the current supplied from the DC-DC converter 360 to the load 390.

The controller 370 determines whether the voltages output from the fuel cell 300 and the rechargeable battery 310 are input to the DC-DC converter 360, and whether the current output from the DC-DC converter 360 is input to the rechargeable battery 310, by switching the switches 330, 340 and 350 based on the measured load current.

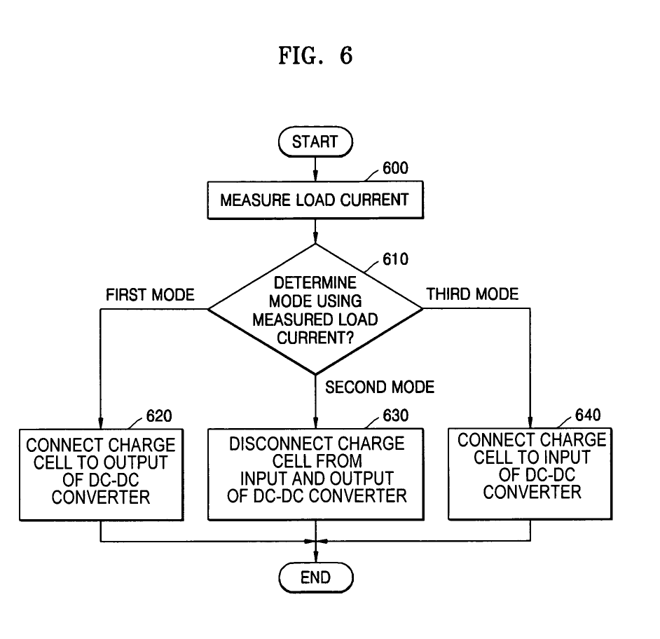

Operation of the power supply apparatus shown in FIG. 3 will now be described in detail with reference to a method of controlling the power supply apparatus illustrated in FIG. 6.

In operation 600, the current measurement unit 380 measures the current supplied from the DC-DC converter 360 to the load 390. Since the load current measured by the current measurement unit 380 is proportional to the power consumed by the load 390, the load current varies according to changes in the power consumption of the load 390.

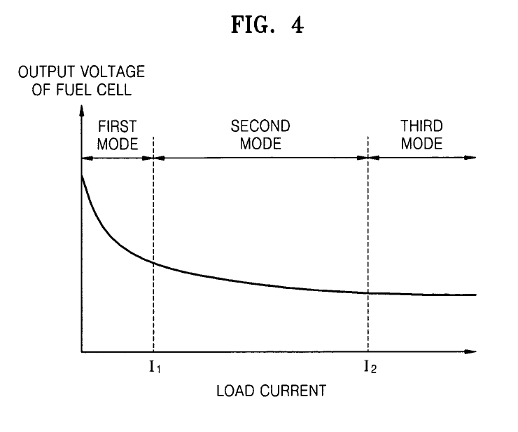

In operation 610, the controller 370 receives a value of the load current as measured by the current measurement unit 380 and determines a current state of the power supply apparatus to be a first mode, a second mode, or a third mode, based on the value of the measured load current. FIG. 4 is a diagram illustrating a method of dividing the current state of the power supply apparatus into the three modes based on the load current. Referring to FIG. 4, the controller 370 may determine the current state of the power supply apparatus to be the first mode if the load current is less than a first current I₁, to be the second mode if the load current is greater than the first current I₁ and less than a second current I₂, and to be the third mode if the load current is greater than the second current I₂.

A method of setting the first and second current values I₁, and I₂, which are reference values to determine the modes, will now be described with reference to FIG. 4. When it is desired to maintain high efficiency and stability of the power supply apparatus and the fuel cell 300, if the power output of the fuel cell 300 is small because the load current is small, performance and stability of the fuel cell 300 decrease. Thus, the first current value I₁ may be set to a value of a minimum current necessary to maintain the performance and stability of the fuel cell 300, according to the characteristics of the fuel cell used. The second current value I₂ may be set at a value of the load current measured by the current measurement unit 380 when the output voltage of the fuel cell 300 is a minimum voltage to maintain the high efficiency required for the DC-DC converter 360.

Thus, the mode of the power supply apparatus is determined based on comparing the measured load current with the reference values I₁ and I₂. Based on the measured load current, the controller 370 determines the mode of operation and generates and outputs signals for switching the switches 330, 340 and 350 included in the switching unit 320 according to the determined mode. In the first mode, in operation 620, the controller 370 generates and outputs signals for turning the first and third switches 330 and 350 on and the second switch 340 off, in order to connect the fuel cell 300 to the input of the DC-DC converter 360 and connect the rechargeable battery 310 to the output of the DC-DC converter 360. In the first mode, power output from the fuel cell 300 is supplied to the load 390 and the rechargeable battery 310 through the DC-DC converter 360, thereby charging the rechargeable battery with power output from the DC-DC converter. Thus, in the first mode, the efficiency of the DC-DC converter 360 is maintained by increasing the current output by the DC-DC converter by charging the rechargeable battery 310 from the fuel cell 300. Thus, a performance decrease of the power supply apparatus due to the low load current is prevented.

In the second mode, in operation 630, the controller 370 generates and outputs signals for turning the first switch 330 on and the second and third switches 340 and 350 off, in order to connect the fuel cell 300 to the input I of the DC-DC converter 360 and disconnect the rechargeable battery 310 from the input and output of the DC-DC converter 360. In the second mode, since the efficiency of the DC-DC converter 360 is maintained, power is supplied to the load 390 from only the fuel cell 300 without using the rechargeable battery 310.

In the third mode, in operation 640, the controller 370 generates and outputs signals for turning the first and second switches 330 and 340 on and the third switch 350 off, in order to connect the fuel cell 300 and the rechargeable battery 310 to the input of the DC-DC converter 360. In this case, by supplying power from both the fuel cell 300 and the rechargeable battery 310 to the load 390, even if the power supplied to the load 390 is high, a voltage drop of the fuel cell 300 is prevented.

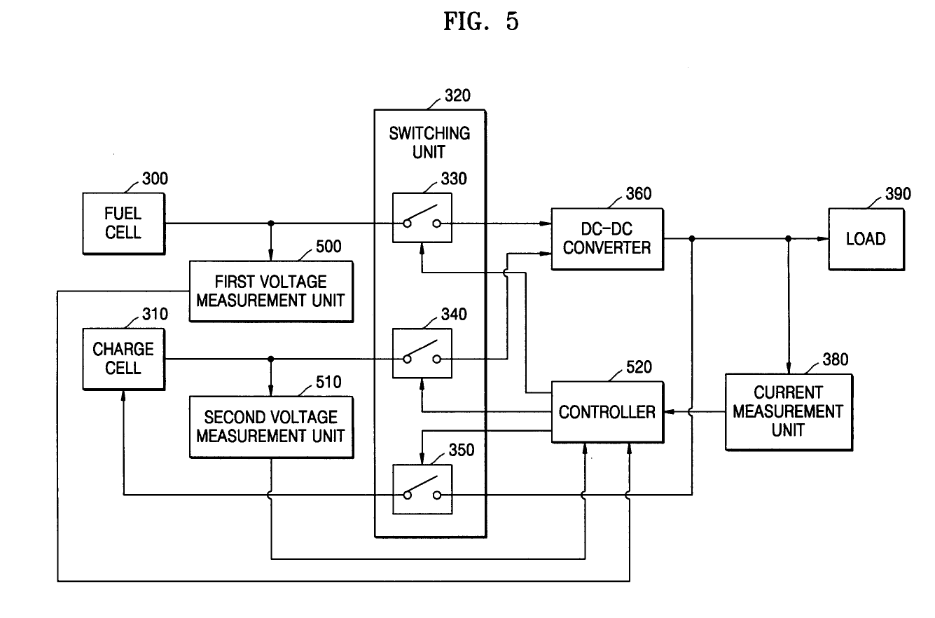

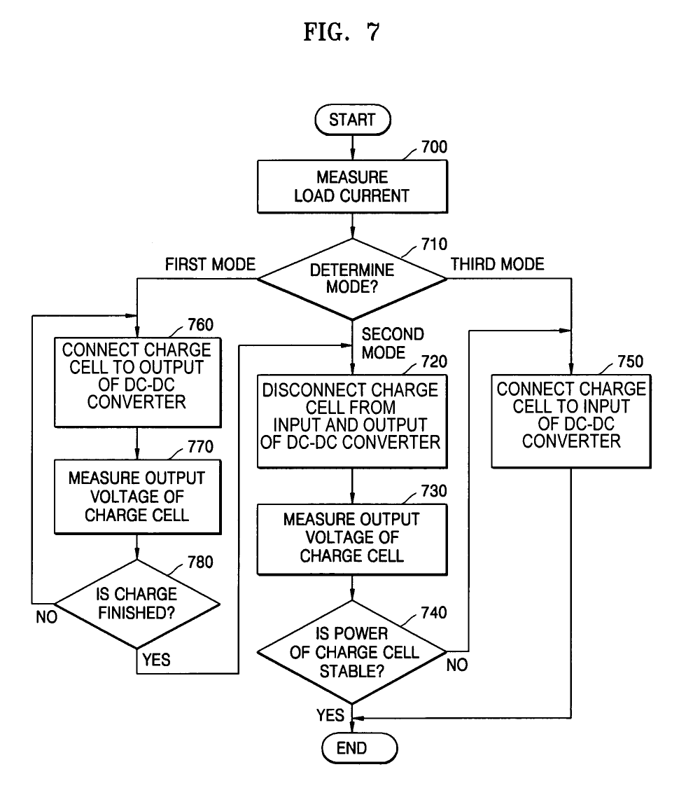

FIG. 5 is a block diagram of a power supply apparatus using a fuel cell according to another embodiment of the present invention. The power supply apparatus shown in FIG. 5 includes the fuel cell 300, the rechargeable battery 310, the switching unit 320 including the three switches 330, 340 and 350, the DC-DC converter 360, a first voltage measurement unit 500, a second voltage measurement unit 510, a controller 520, and the current measurement unit 380. The operation of the power supply apparatus shown in FIG. 5 will now be described in detail with reference to a method of controlling the power supply apparatus illustrated in FIG. 7.

In operation 700, the current measurement unit 380 measures the current supplied from the DC-DC converter 360 to the load 390. In operation 710, the controller 520 receives a value of the load current measured by the current measurement unit 380 and determines a current state of the power supply apparatus to be a first mode, a second mode, or a third mode, based on the value of the load current.

In the second mode, in operation 720, the controller 520 turns the first switch 330 on and the second and third switches 340 and 350 off, in order to supply power from only the fuel cell 300 to the load 390 via the DC-DC converter 360. While the fuel cell 300 is supplying the power to the load 390, in operation 730, the first voltage measurement unit 500 measures the output voltage of the fuel cell 300. In operation 740, the controller 520 determines whether the power of the fuel cell 300 is stable based on the output voltage of the fuel cell 300 measured by the first voltage measurement unit 500. As a result of the determination, if the power of the fuel cell 300 is unstable, in operation 750, the controller 520 turns the first and second switches 330 and 340 on and the third switch 350 off, in order to connect both the fuel cell 300 and the rechargeable battery 310 to the input of the DC-DC converter 360, thus switching to the third mode based on the measured output voltage of the fuel cell. Thus, even if the power of the fuel cell 300 is unstable, stable power is supplied to the load 390 from the fuel cell 300 and the rechargeable battery 310 together.

In the first mode, in operation 760, the controller 520 turns the first and third switches 330 and 350 on and the second switch 340 off, in order to connect the fuel cell 300 to the input of the DC-DC converter 360 and connect the rechargeable battery 310 to the output of the DC-DC converter 360. While the rechargeable battery 310 is charged from the output from the DC-DC converter 360, in operation 770, the second voltage measurement unit 510 measures the output voltage of the rechargeable battery 310. In operation 780, the controller 520 determines whether the rechargeable battery 310 is fully charged based on the output voltage of the rechargeable battery 310 measured by the second voltage measurement unit 510. As a result of the determination, if the rechargeable battery 310 is fully charged, in operation 720, the controller 520 turns the first switch 330 on and the second and third switches 340 and 350 off, in order to stop recharging the battery 310, thus switching from the first mode to the second mode.

Some aspects of the embodiments of the present invention may be provided as computer programs and implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, DVDs, etc.), and storage media such as carrier waves (e.g., transmission through the internet).

As described above, in a power supply apparatus using a fuel cell and a method of controlling the power supply apparatus according to embodiments of the present invention, when power is supplied to a load by converting a voltage output from the fuel cell using a DC-DC converter, the efficiency of the DC-DC converter can be maintained even when the power supplied to the load changes, by controlling connections between the fuel cell, a rechargeable battery and an input and an output of the DC-DC converter based on at least one of the current flowing to the load, an output voltage of the fuel cell and an output voltage of the rechargeable battery, thereby supplying the power to the load for a long time with stable efficiency.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A power supply apparatus comprising:
a fuel cell;
a rechargeable battery;
a DC-DC converter converting a voltage input from the fuel cell and/or the rechargeable battery to a voltage to be supplied to a load;
a current measurement unit measuring a current output from the DC-DC converter and flowing to the load; and
a controller controlling connections between the rechargeable battery and an input and an output of the DC-DC converter to determine whether a voltage is input from the rechargeable battery to the DC-DC converter and whether the rechargeable battery is charged using power supplied from the DC-DC converter based on the measured load current.

2. The apparatus of claim 1, wherein the controller connects the rechargeable battery to the output of the DC-DC converter to charge the rechargeable battery if the measured load current is less than a first value.

3. The apparatus of claim 1, wherein the controller disconnects the rechargeable battery from the input and output of the DC-DC converter if the measured load current is greater than the first value and less than a second value.

4. The apparatus of claim 1, wherein the controller connects the rechargeable battery to the input of the DC-DC converter to input the voltage from the rechargeable battery to the DC-DC converter if the measured load current is greater than the second value.

5. The apparatus of claim 2, wherein the second value is set to maintain a predetermined efficiency of the DC-DC converter.

6. The apparatus of claim 3, wherein the second value is set to maintain a predetermined efficiency of the DC-DC converter.

7. The apparatus of claim 4, wherein the second value is set to maintain a predetermined efficiency of the DC-DC converter.

8. The apparatus of claim 1, wherein the controller:
determines a current state of the power supply apparatus to be a first mode if the measured load current is less than a first value, to be a second mode if the measured load current is greater than the first value and less than a second value, and to be a third mode if the measured load current is greater than the second value; and
controls the connections between the rechargeable battery and the DC-DC converter to:
connect the rechargeable battery to the output of the DC-DC converter if the current state of the power supply apparatus is the first mode,
disconnect the rechargeable battery from the input and the output of the DC-DC converter if the current state of the power supply apparatus is the second mode, and
connect the rechargeable battery to the input of the DC-DC converter if the current state of the power supply apparatus is the third mode.

9. The apparatus of claim 1, further comprising:
a voltage measurement unit measuring an output voltage of the rechargeable battery, wherein
the controller determines whether the rechargeable battery is fully charged based on a value of the measured output voltage of the rechargeable battery and disconnects the rechargeable battery from the output of the DC-DC converter if the rechargeable battery is fully charged.

10. The apparatus of claim 1, further comprising:
a voltage measurement unit measuring an output voltage of the fuel cell, wherein
the controller determines whether power of the fuel cell is stable based on a value of the measured output voltage of the fuel cell and connects the rechargeable battery to the input of the DC-DC converter if the power of the fuel cell is unstable.

11. The apparatus of claim 1, further comprising:
a first voltage measurement unit measuring an output voltage of the rechargeable battery; and
a voltage measurement unit measuring an output voltage of the fuel cell, wherein:
the controller determines whether the rechargeable battery is fully charged based on a value of the measured output voltage of the rechargeable battery and disconnects the rechargeable battery from the output of the DC-DC converter if the rechargeable battery is fully charged, and
the controller determines whether power of the fuel cell is stable based on a value of the measured output voltage of the fuel cell and connects the rechargeable battery to the input of the DC-DC converter if the power of the fuel cell is unstable.

12. A method of controlling a power supply apparatus using a fuel cell, the method comprising:
measuring a current flowing to a load from an output of a DC-DC converter having an input being supplied with first power from the fuel cell;
determining whether second power is to be supplied from a rechargeable battery to the input of the DC-DC converter and whether the rechargeable battery is to be charged using power output from the DC-DC converter based on the measured load current; and
controlling connections between the rechargeable battery and the input and the output of the DC-DC converter according to a result of the determination.

13. The method of claim 12, wherein:
if the measured load current is less than a predetermined value, the rechargeable battery is charged from the output from the DC-DC converter.

14. The method of claim 12, wherein:
if the measured load current is less than a predetermined value, the rechargeable battery is connected to the output of the DC-DC converter.

15. The method of claim 12, wherein:
if the measured load current is greater than a predetermined value, the rechargeable battery supplies the second power to the DC-DC converter.

16. The method of claim 12, wherein:
if the measured load current is greater than a predetermined value, the rechargeable battery is connected to the input of the DC-DC converter.

17. The method of claim 12, further comprising:
determining a current state of the power supply apparatus to be a first mode if the measured load current is less than a first value, to be a second mode if the measured load current is greater than the first load value and less than a second value, and to be in a third mode if the measured load current is greater than the second value, connecting the rechargeable battery to the output of the DC-DC converter if the current state of the power supply apparatus is the first mode,
disconnecting the rechargeable battery from the input and the output of the DC-DC converter if the current state of the power supply apparatus is the second mode, and
connecting the rechargeable battery to the input of the DC-DC converter if the current state of the power supply apparatus is the third mode.

18. The method of claim 14, further comprising:
determining whether the rechargeable battery is fully charged by measuring an output voltage of the rechargeable battery, and
if the rechargeable battery is fully charged, disconnecting the rechargeable battery from the output of the DC-DC converter.

19. The method of claim 12, further comprising:
determining whether the first power of the fuel cell is stable by measuring an output voltage of the fuel cell, and
if the power of the fuel cell is unstable, connecting the rechargeable battery to the input of the DC-DC converter.

20. A computer readable medium having recorded thereon a computer readable program for controlling a power supply apparatus having a DC-DC converter, a fuel cell and a rechargeable battery supplying power to a load, the computer readable medium comprising:
instructions for measuring a current flowing to the load from an output of the DC-DC converter, the DC-DC converter being supplied with first power from the fuel cell;
instructions for determining whether second power is to be supplied from the rechargeable battery to an input of the DC-DC converter and whether the rechargeable battery is to be charged using power output from the DC-DC converter based on the measured load current; and
instructions for controlling connections between the rechargeable battery and the input and the output of the DC-DC converter according to a result of the determination.

21. The computer readable medium of claim 20, further comprising:
instructions for connecting the rechargeable battery to the output of the DC-DC converter if the measured load current is less than a predetermined value,

22. The computer readable medium of claim 20, further comprising:
instructions for connecting the rechargeable battery is connected to the input of the DC-DC converter if the measured load current is greater than a predetermined value.

23. The computer readable medium of claim 20, further comprising:
instructions for measuring an output voltage of the rechargeable battery, and
instructions for disconnecting the rechargeable battery from the output of the DC-DC converter, if the rechargeable battery is fully charged.

24. The computer readable medium of claim 20, further comprising:
instructions for measuring an output voltage of the fuel cell, and
instructions for determining whether the first power of the fuel cell is stable based on the measured output voltage, and
instructions for connecting the rechargeable battery to the input of the DC-DC converter if the power of the fuel cell is unstable.

25. A method controlling a power supply apparatus having a DC-DC converter, a fuel cell and a rechargeable battery, and supplying power to a load, the method comprising:
measuring a current flowing to the load from the DC-DC converter, the DC-DC converter being supplied with first power from the fuel cell; and
supplying the DC-DC converter with additional power from the rechargeable battery, if the first power becomes unstable.

26. A method controlling a power supply apparatus having a DC-DC converter, a fuel cell and a rechargeable battery, and supplying power to a load, the method comprising:
measuring a current flowing to the load from the DC-DC converter, the DC-DC converter being supplied with first power from the fuel cell; and
supplying additional power to the DC-DC converter if measured current exceeds a predetermined value.

27. A method controlling a power supply apparatus having a DC-DC converter, a fuel cell and a rechargeable battery, and supplying power to a load, the method comprising:
measuring a current flowing to the load from the DC-DC converter, the DC-DC converter being supplied with power from the fuel cell; and
connecting the rechargeable battery to an output of the DC-DC converter to charge the battery if the measured load current is less than a predetermined value.

28. The method of claim 27, further comprising:
connecting the rechargeable battery to supply additional power to the DC-DC converter if the measured load current exceeds a predetermined value.

29. A method maintaining an efficiency of a power supply apparatus having a DC-DC converter, a fuel cell and a rechargeable battery, and supplying power to a load, the method comprising:
measuring a current flowing to the load from the DC-DC converter, the DC-DC converter being supplied with power from the fuel cell;
connecting the rechargeable battery to the DC-DC converter to charge the battery only if the measured load current is less than a first value;
disconnecting the rechargeable battery from the DC-DC converter if the measured load current is greater than the first value and less than a second value; and
connecting the rechargeable battery to the DC-DC converter to supply additional power to the DC-DC converter if the measured load current is greater than the second value.

30. A method maintaining an efficiency of a power supply apparatus having a DC-DC converter, a fuel cell and a rechargeable battery, and supplying power to a load, the method comprising:
measuring a current flowing to the load from the DC-DC converter, the DC-DC converter being supplied with power from the fuel cell;
measuring an output voltage of the fuel cell while supplying the DC-DC converter;
measuring a voltage of the rechargeable battery while the battery is being recharged from an output of the DC-DC converter; and
connecting the rechargeable battery to either the output of the DC-DC converter to recharge the rechargeable battery or the input of the DC-DC converter to supply additional power to the DC-DC converter based on at least one of the current flowing to the load, the output voltage of the fuel cell and the voltage of the rechargeable battery while being recharged.
